(19) United States
(12) Patent Application Publication
(10) Pub. No.: US 2014/0343958 A1
(43) Pub. Date: Nov. 20, 2014

(54) PHARMACEUTICAL SAFETY MONITORING SYSTEM AND METHOD

(71) Applicant: WINJJE PTY LTD, Ourimbah (AU)

(72) Inventor: Robert Heard, Ourimbah (AU)

(73) Assignee: WINJJE PTY LTD, Ourimba (AU)

(21) Appl. No.: 14/279,827

(22) Filed: May 16, 2014

(30) Foreign Application Priority Data
May 18, 2013 (AU) 2013 901 763

(51) Int. Cl. G06F 19/00

(52) U.S. Cl. CPC G06F 19/3418
USPC 705/2

(57) ABSTRACT

The present application discloses a system and method for providing real-time supervision of adverse drug reactions in patients.

### BACKGROUND OF THE INVENTION

The present invention relates to the supervision of adverse drug reactions which is known as pharmacovigilance (PV) or pharmacosurvillance.

The importance of ensuring drug safety has long been recognized and as a result there has evolved a complex and highly regulated system of preclinical and clinical trials. Increasingly it has been recognized that important adverse drug reactions (ADRs) may not be detected by premarketing clinical trials and consequently various postmarketing surveillance systems have been developed. All major OECD jurisdictions now require ongoing postmarket surveillance activities. These are undertaken in the main by government bodies and the WHO, pharmaceutical companies and various public organizations. Despite these systems, concern has risen again in recent years following several high profile scares. In the US the Federal Drug Administration (FDA) reported 426 recalls in 2008, more than 1,700 recalls in 2009 and more than 300 in the first 6 months of 2010. According to peer-reviewed published studies, FDA-approved prescription drugs injure 2.2 million Americans each year and kill approximately 100,000 Americans each year. Realistic estimates put the number of drug induced deaths of prescription drug takers at over 200,000 people annually in the United States alone. Regulators are under pressure from legislators to ensure rapid detection of unexpected ADRs after marketing. Also, the pharmaceutical sector is seeking technologies to allow such safety monitoring to occur post-approval to prevent even further escalation in the time and cost of drug development.

Safety of medications in developing countries remains largely unmonitored and unknown, and increasing legislation for PV in developing countries is likely.

The core data on which prior art PV systems rely remains the spontaneous reporting, to a national body, of individual suspected ADRs usually as brought to the attention of, and interpreted by, health professionals. Many problems exist with the data gathered in this way, including under-reporting, failure to recognize a clinical event as an ADR, failure to recognize non-serious ADRs, failure to recognize drug-drug interactions, biases in which ADRs are pre-sorted based on prior expectations, and delays in reporting. These deficiencies in the primary data inevitably affect all subsequent analysis of the data. Despite these shortcomings spontaneous reporting remains the most common data gathering process, however. It is thought that approximately 4.6 million ADRs were reported by 2009 and approximately 250,000 new ADRs were reported every year.

In the US the FDA's reporting system is Medwatch. Medwatch depends on voluntary reporting by healthcare professionals, patients and consumers and aims to detect safety hazard signals (i.e. a higher than “normal” number of occurrences of an ADR). If a signal is detected, the FDA can issue medical product safety alerts, or order product recalls, withdrawals, or labeling changes. Raw data from the Medwatch system, together with adverse drug reaction reports from manufacturers as required by regulation, are part of a public database.

In Europe a similar role is played by Eudravigilance, and by similar government regulatory bodies in other jurisdictions (for example, MHRA, CHM, and the Yellow Card Scheme in the UK, TGA in Australia, and PMDA and MHLW in Japan).
100 countries participate in an international collaboration, submitting their ADR reports to the WHO-sponsored monitoring centre UMC in Uppsala, Sweden.

In addition to the physician-dependent spontaneous reporting of ADRs, regulatory authorities increasingly require various active surveillance methods to be undertaken for products considered to be of higher risk. Existing active surveillance methods include sentinel site surveillance, intensive monitoring schemes, prescription event monitoring, registries, comparative observational studies and cross-sectional studies. Active surveillance provides much more complete data but existing methods are generally slow, expensive and examine relatively limited population samples.

There are a number of active public and academic systems such as The International Society of Pharmacovigilance and the Boston Collaborative Drug Surveillance Program.

The FDA Center for Drug Evaluation and Research CDER has published guidelines for risk evaluation and mitigation strategies (REMS). For the majority of drugs, labeling and existing voluntary reporting of ADRs are considered adequate. However, in the case of higher risk drugs the FDA requires additional postmarketing surveillance to be undertaken. Additional REMS elements (elements to ensure safe use or ETASUs) can be submitted voluntarily by manufacturers. The FDA provides a number of example ETASUs, including restriction of the drug to patients meeting certain criteria. Examples of such criteria include a requirement for patients to undergo periodic testing or re-examination.

The EU has published similar guidelines for risk management (EU-RMP). For products where no special concerns have arisen, routine pharmacovigilance should be sufficient for post-authorization safety monitoring. However where risks are identified or potential risks are considered likely, or important information is missing, additional activities are necessary. These guidelines are similar to those required by the FDA. A RMP can be proposed by a manufacturer or required by the regulatory body. It may be submitted at any time in a product's life cycle and its effectiveness should be measurable. It should address safety findings that have not been adequately addressed by clinical data, for example genotoxicity, carcinogenicity, reproductive toxicity, drug interactions and where particular populations have not been adequately studied in the drug's pre-authorization phase, for example children, the elderly, pregnant or lactating women, patients with known comorbidities, subpopulations with genetic polymorphisms and different racial groups.

As at the priority date, pharmacovigilance activities are undertaken almost exclusively in developed countries and negligible PV is undertaken in developing countries. As large scale therapeutic programs become more common in developing regions there will be increasing political and social pressure to ensure these drugs are safe. Pharmacovigilance in developing countries may be more practicable and therefore more effective, if it can be provided by means of automated systems and widespread mobile phone availability than if it is dependent on access to scarce healthcare professionals and facilities.

The genesis of the present invention is a desire to provide a system and method for prescription drug users to supervise adverse drug reactions.

### SUMMARY OF THE INVENTION

In accordance with a first aspect of the present invention there is disclosed a method of providing real time supervision of adverse drug reactions in patients using prescription and non-prescription drugs, said method comprising the steps of:

(i) providing a host computer in which is stored adverse drug reaction data, patient data, and outgoing messages;

(ii) receiving an incoming message from a patient and searching same for one or more keys which characterize said incoming message;

(iii) dentifying said key(s) with one or more keywords stored in said drug reaction data to determine if there is a match therebetween;

(iv) in the event of a match, determining if an outgoing message should be sent and, if so, sending same; and

(v) updating said patient data and/or drug reaction data with said matched keyword(s).

In accordance with a second aspect of the present invention there is disclosed a real time supervisory system for adverse drug reactions in patients using prescription and non-prescription drugs, said system comprising a host computer having an input and an output each respectively connected to at least one public communications system to respectively receive and send messages, said host computer incorporating a database in which is stored adverse drug reaction data, patient data, and outgoing messages, said host computer further including a screen incoming message means connected to said input to screen incoming messages from a patient and search same for one or more keys which characterize said incoming messages, said host computer identifying said key(s) with one or more keywords stored in said drug reaction data to determine if there is a match therebetween, and said host computer including logic means connected with said database and an outgoing message generating means to determine in the event of a match whether an outgoing message should be sent, and if so sending same, said logic means also updating said patient data and/or drug reaction data with said matched keyword(s).

### BRIEF DESCRIPTION OF THE DRAWINGS

A preferred embodiment of the present invention will now be described, with reference to the accompanying drawings in which:

FIG. 1 is a block diagram representing the functionality of a host computer;

FIG. 2 is a schematic representation of the contents of a main database;

FIG. 3 is a schematic representation of the contents of a message database;

FIG. 4 is a flow chart illustrating a first patient enrolment scenario;

FIG. 5 is a flow chart illustrating a second patient enrolment scenario;

FIG. 6 is a flow chart of a computer patient interface; and

FIG. 7 is a block diagram schematically illustrating possible communication channels.

### DETAILED DESCRIPTION OF THE PREFERRED EMBODIMENTS

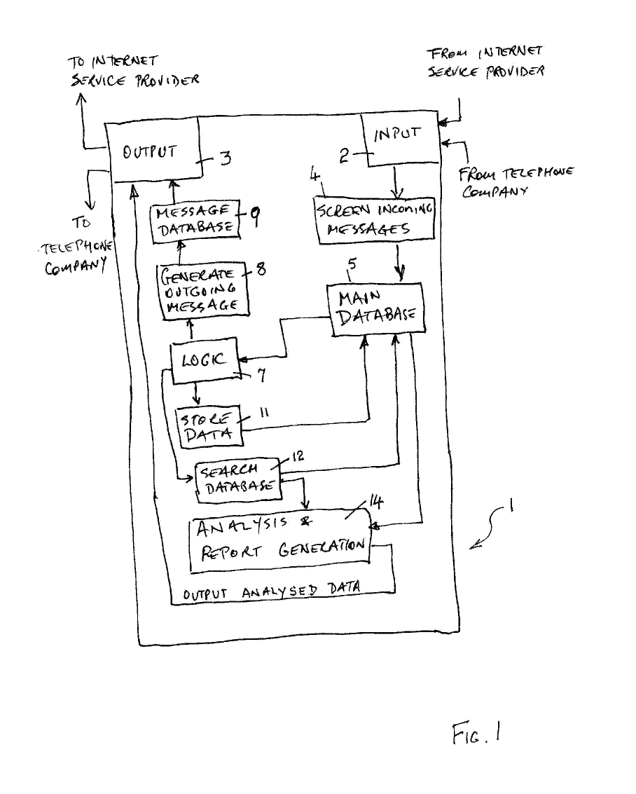

As seen in FIG. 1, a host computer 1 includes a communications input 2 and a communications output 3 by means of which signals from telephone companies, internet providers, and the like can be received and transmitted respectively. The input 2 is connected to a screen 4 for incoming messages which utilizes technology first created to search the World Wide Web, to detect keys in incoming messages as will be explained in more detail hereafter. The screen 4 is connected to a main database 5.

The main database 5 is connected to a logic module 7 which is connected to a generator 8 of outgoing messages which is in turn connected to a message database 9 which is in turn connected to the output 3.

The logic module 7 is also connected to a store data module 11 which is in turn connected to the main database 5. The logic module 7 is also connected to a search database module 12 which is connected both to the main database 5 and to a generator of analysis and reports 14 which is also connected with the main database 5 and with the output 3.

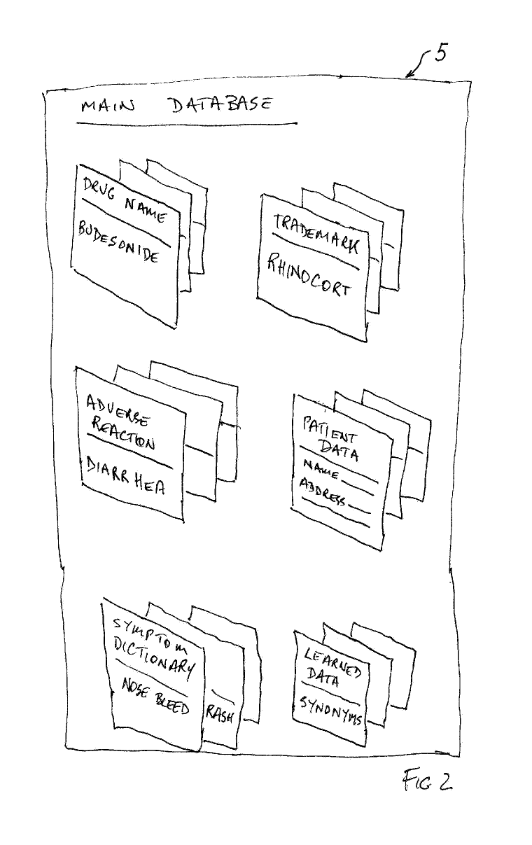

As seen in FIG. 2, the main database 5 includes a number of sub-databases all of which are logically interlinked. As illustrated in FIG. 2 the sub-databases include the name of the drug, which is the accepted generic pharmaceutical name, a trade mark database which includes the trade mark, or each of the various trademarks, in respect of which a given pharmaceutical drug is sold. Another sub-database includes various adverse reactions such as diarrhea, nausea, etc. A further sub-database includes all the data required to be stored in respect of individual patients which includes not only their name and address but also a unique identification number, the name of their physician, where relevant their medical history, and so on.

In addition, there is a symptom dictionary which includes all symptoms which are thought able to be caused by any prescription drugs. Furthermore, there is a learned data sub-database which includes not only synonyms but also accrued information as a result of receipt of, and analysis of, messages from patients.

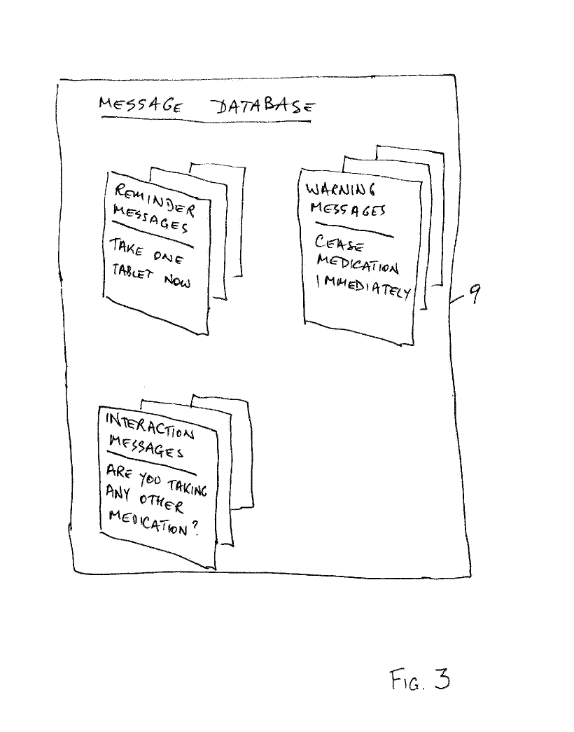

Turning now to FIG. 3, the message database 9 includes three sub-databases which are respectively reminder messages, warning messages, and interaction messages. Reminder messages are able to be sent at predetermined times and are able to remind a patient to take a specific dose of a specific medication, essentially at the time the reminder is sent. Warning messages are able to be sent to patients in the event that some potentially serious adverse drug reaction is detected, either in that patient or in others. Interaction messages are able to be sent to a patient to solicit further information from the patient by means of a follow up message to be sent by the patient in reply to the interaction message.

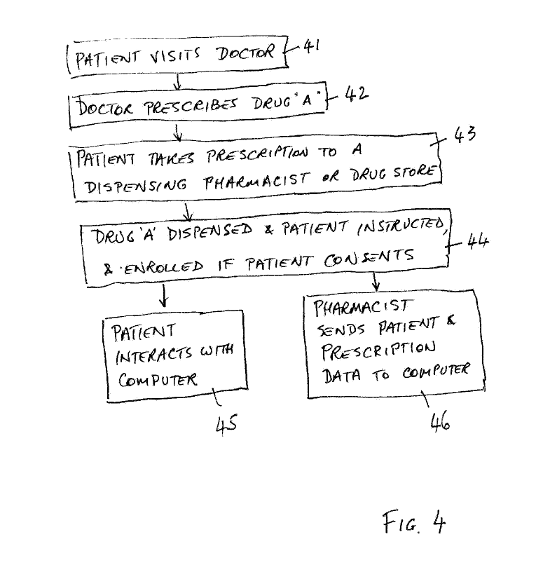

FIG. 4 is a flow chart illustrating the steps involved in one scenario by means of which a patient is enrolled with the host computer 1. As seen in FIG. 4, the first step 41 is that the patient visits a doctor or physician and, as a result of that consultation, the doctor in step 42 prescribes drug “A” for the patient. In the next step 43, the patient takes the prescription to a dispensing pharmacist or drug store in order to have the prescription filled. In the next step 44 the drug “A” is dispensed and the patient is instructed by the pharmacist as to the nature of the pharmacovigilance system and, if the patient consents, then as indicated in step 44 the patient is enrolled in the system. This involves the pharmacist sending the patient and prescription data to the computer 1 as indicated by step 46 and also the patient interacting with the computer 1 as indicated at step 45 as will be explained hereafter in more detail.

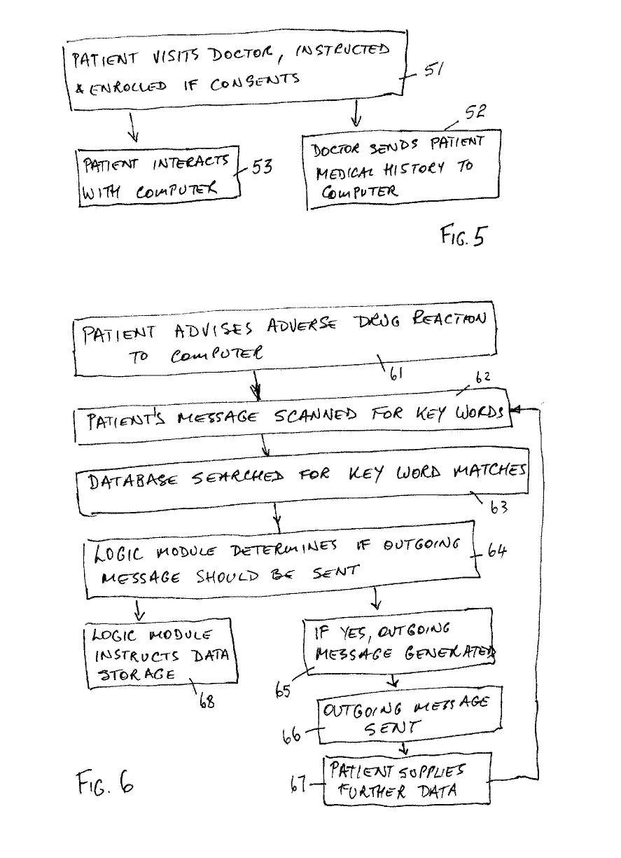

Alternatively, as indicated in FIG. 5, the patient can visit a doctor and as indicated in step 51 be instructed by the doctor as to the pharmacovigilance system and be enrolled following the granting of consent. The doctor then, as indicated in step 51, sends the patient's medical history to the host computer 1. Thereafter, as indicated in step 53, the patient interacts with the host computer 1.

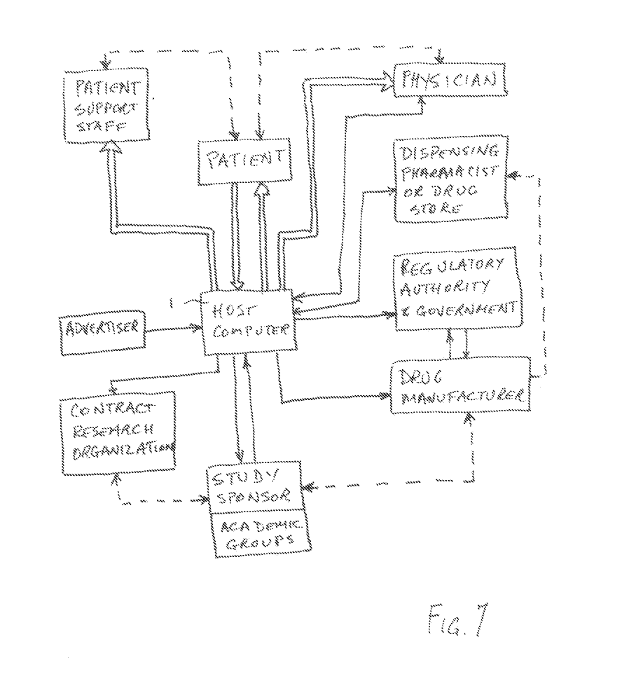

The nature of this interaction is schematically illustrated in FIG. 6. The first step is that as indicated in step 61, the patient advises the computer 1 of an adverse drug reaction. This can be done in many ways of which the most easily comprehended is the short message system (SMS) utilized with mobile or cell phones. However, the patient can also use a smart phone with a dedicated application, or a personal computer communicating either via a customized mobile application, via a voice message, or via the web and, if necessary, using voice recognition software.

The messages are received by the input 2 and passed to the screen 4 of incoming messages where, as indicated in steps 62, the patient's messages are scanned for keys (words which have some particular relevance). The scanning utilizes the technology disclosed in International Patent Application No. PCT/AU2010/001527 (WO 2011/057355) to the present applicant, the contents of which are hereby incorporated in the present specification for all purposes. Thereafter, as indicated in step 63, the database 5 is searched for keyword matches and the result passed to the logic module 7 which, in step 64 determines if an outgoing message should be sent. If an outgoing message is to be sent, then as indicated in step 65, the logic module 7 instructs the generator 8 of outgoing messages and an appropriate message selected from the message database 9 is sent, as indicated in step 66, by the output 3. Thereafter, as indicated in step 67, the patient supplies further data by means of another message sent to the input 2 and then steps 62-64, at least, are repeated. In addition, as indicated at step 68, the logic module 7 can also instruct that data be stored in the main database 5.

FIG. 7 illustrates in schematic form the various message sending, data links and communication paths between the various participants. As indicated by double lines in FIG. 7 the patient can send and receive messages to and from the host computer 1. The host computer 1 can also send messages to the patient's physician and to the patient's support staff (for example, nursing home staff), if any. In addition, the host computer can send and receive data and reports to the patient's physician and the patient's dispensing pharmacist or drug store, and the study sponsor (and its associated academic groups, if any). The host computer 1 can also send data and reports to regulatory authorities and government, the drug manufacturer(s) and any contract research organization. Finally an advertiser, if any, can send data and reports to the host computer 1.

Indicated in broken lines in FIG. 7 are channels of communication, external to the host computer which are maintained by some of the various participants.

### Example 1

Utilizing either the scenario outlined in FIG. 4 or outlined FIG. 5, a patient Mrs. Smith, is prescribed Diazepam by her doctor and is sold tablets bearing the trade mark VALIUM by her pharmacist. Mrs. Smith is then enrolled in the host computer 1 and allocated a unique identification number, for example, 12345. Two weeks after receiving the drug, Mrs. Smith sends an SMS message to the host computer reading “This is #12345, I have a runny tummy”. The message is received by the input 2 and screened by the screen 4 which detects the key “runny tummy” as being a possible side effect. That is to say, the logic module 7 assesses that “runny tummy” may be a synonym for “diarrhea”. As a consequence, the logic module 7 in step 64 determines that an outgoing message should be sent and the outgoing message reading “Thank you, by “runny tummy” do you mean “diarrhea?” is sent via return SMS.

Mrs. Smith then replies as indicated in step 67 by sending an SMS message reading “Yes”.

Then step 62-66 are repeated but this time the outgoing interaction message reads “Are you taking any other medication?”.

To this message Mrs. Smith replies “Yes, I started taking RHINOCORT two days ago”. The keys detected by the screen 4 in this incoming message are “RHINOCORT”; “two days” and “ago”. The logic module 7 is able to link the trade mark RHINOCORT with the pharmaceutical drug name Budesonide and therefore enters into the main database in relation to the patient data that Mrs. Smith has experienced diarrhea within two days of commencing to take Budesonide whilst also taking Diazepam. In addition, this data is logged in the learn data sub-database since the exchange with Mrs. Smith has a statistical significance of a single adverse drug reaction report.

Thousands of other patients are similar making reports to the host computer 1 and thus progressively the learned database accumulates statistics which are able to be analyzed by the logic module 7 in conjunction with the search database module 12 and generator 14. These statistical analyses look for “signals” which may be regarded as clusters of higher than normal incidences of specific adverse reactions. This numerical data can be filtered and thresholds of significance can be set to predetermined levels. These predetermined levels can be adjusted.

### Example 2

A patient is on several previous medications and starts a new one.

The patient experiences a loss of taste.

The patient logs a message “For the last three days things have tasted different and today I can't taste anything”.

Screen 4 detects the keys tasted, taste, last three days.

Logic module 7 identifies previous reports of dysgeusia/ageusia with the new medication.

Either: The host computer 1 identifies previous reports of dysgeusia/ageusia with the new medication, the occurrence of the adverse drug reaction (ADR) is noted and an acknowledgement is sent to patient,

Or: The host computer 1 identifies no previous reports of this ADR, and so the ADR database is updated.

Further messages from other patients are received containing the keys taste, funny, mouth, food etc.

Tests of significance are applied in real time, and a “signal” (or a cluster of notifications) is detected.

An automatic message is sent to these patients notifying them that they may be experiencing a new side effect.

Further advice may then be provided where appropriate, e.g. a suggestion to see their physician at the earliest opportunity.

Additional notifications may also be sent to the treating physician, a trial sponsor, a pharmacovigilance authority etc.

The “signal” continues to be monitored in real-time.

Further data analysis then detects that the ADR only occurs in relation to specific drug combinations, or specific demographic criteria such as age or other health conditions.

The threshold for detecting new “signals” can be modified according to ADR severity, so for example, all cases of possible heart failure might be considered significant where many minor symptoms are not be weighted so highly.

### Example 3

The same system as outlined above detects a “signal” comprising an increased incidence of chest pain only in men aged over 50 and only in the second year of treatment with drug A.

Due to the severity of this particular symptom the threshold is set to be sensitive. Patients logging this symptom receive an acknowledgement and a message to see their doctor.

As the importance of the “signal” is increasingly confirmed, and following receipt of advice from the drug manufacturer, expert physician group or regulatory authority; more specific and detailed advice can be provided to the patients in real time. For example a warning message “This complaint may be important. It is recommended that you attend your nearest hospital emergency department as soon as possible” can be sent. Alternatively, a message may contain a link to detailed expert advice online, a regulatory body or manufacturer statement etc.

### Example 4

A patient logs a message “I'm feeling dizzy and lightheaded since starting the new drug”.

The logic module 7 responds to the keys dizzy, and lightheaded and sends an interaction message back to the patient reading.

“Are you dizzy

A) all the time,

B) when you stand up, or

C) when you move around”.

The patient responds “B”.

The logic module 7 recognizes that patient's blood pressure may be falling when he stands up, confirms this as a recognized ADR and recommends a predetermined course of action (for example by sending a warning message “It is recommended that you withhold tonight's medication dose and contact your doctor tomorrow”).

The logic module 7 also preferably alerts the patient's physician simultaneously.

### Example 5

A physician prescribes a new drug for one of her patients. The patient can be provided with access to the host computer 1 on a dedicated mobile platform (e.g. a smartphone) which is loaned to the patient for a period of time. This enables any new symptoms experienced by the patient to be recorded and analyzed in real time, compared with the experiences of other patients prescribed the same drug, and the patient's physician notified of any new symptoms. As a consequence, appropriate action can be recommended without significant delay.

Now that one embodiment of the invention has been described, the following features of the embodiment are summarized below:

A. Principal Elements
1. The fundamental idea of utilizing a short messaging or microblogging service and real time data analysis for pharmacovigilance or pharmacosurveillance.
2. The linguistic analysis of patient self-reported symptoms for detecting side effects from new medicines.
3. The method of responding in real time to short messages from patients concerning their medical symptoms and in particular those which may be side effects of medication or effects of medication interactions.
4. The real time analysis of short messages containing health symptoms information for detecting signals, trends and associations, both for population screening and for individual case management (i.e. a clinical tool).
5. A smart database to store and linguistically analyze spontaneous patient symptoms and observations to form classification system for patient spontaneous symptom language.

B. Pharmacovigilance Elements
1. The use of mobile phone-based short messaging technology for undertaking pharmacovigilance in developing countries.
2. An automated response system to patient generated symptom descriptions which prompts patients to give further details to clarify side-effect.
3. A system to accumulate and on-sell patient symptom data analyzed according to patient characteristics, drugs and doses taken (prescription and over the counter, or OTC).
4. A system for prompting patient responses at set or random times to quiz patient for activity state, state of mind, state of ease or symptom severity as novel quality-of-life tool.
5. A multilingual system that prompts for symptoms based on simple pictograms shown on screen.

C. Drug Trial Elements
1. The use of short messaging technology for conducting clinical drug trials.
2. A smart-phone voice mail or text reminder to take medication at certain times.
3. A system to beep and show which tablet (by picture of actual tablets) needs to be taken at certain times of day, with text back reply to automated monitoring system that tablet has been taken.

D. Patient Care Elements
1. The above system linked to an automated warning message to carer (or trigger phone call) if tablet prompt ignored repeatedly.
2. To alert a patient's physician regarding trending ADRs and patient-reported symptoms and “red flag” events such as unscheduled medical centre visits, emergency visits, hospital admission, enrolment in clinical trial etc.
3. As a novel clinical tool, provided to patients prescribed a new drug and serving as an individual safety monitoring system for that patient for a defined period of time.
4. An automated alert system to medical carers if certain symptoms are blogged by patients.
5. The above system tailored for particular high risk patient characteristics.

The foregoing describes only one embodiment of the present invention and modifications, obvious to those skilled in the pharmacovigilance arts, can be made thereto without departing from the scope of the present invention

The term “comprising” (and its grammatical variations) as used herein is used in the inclusive sense of “including” or “having” and not in the exclusive sense of “consisting only of”.

1. A method of providing real time supervision of adverse drug reactions in patients using prescription and non-prescription drugs, said method comprising the steps of:
(i) providing a host computer in which is stored adverse drug reaction data, patient data, and outgoing messages;
(ii) receiving an incoming message from a patient and searching same for one or more keys which characterize said incoming message;
(iii) identifying said key(s) with one or more keywords stored in said drug reaction data to determine if there is a match therebetween;
(iv) in the event of a match, determining if an outgoing message should be sent and, if so, sending same; and
(v) updating said patient data and/or drug reaction data with said matched keyword(s).

2. The method as claimed in claim 1 including the further step of:
(vi) including in said outgoing message at least one interaction message which is intended to solicit a reply message from said patient; and
(vii) in the event of a reply message repeating steps (ii)-(v).

3. The method as claimed in claim 2 including the further steps of:
(viii) including in said outgoing messages at least one warning message.

4. The method as claimed in claim 3 including the further steps of:
(ix) including in said outgoing messages at least on reminder message; and
(x) sending a reminder message to said patient at predetermined times.

5. The method as claimed in claim 1 including the further step of searching said updated database to analyze same and output said analyzed data to one or more recipients.

6. A real time supervisory system for adverse drug reactions in patients using prescription and non-prescription drugs, said system comprising a host computer having an input and an output each respectively connected to at least one public communications system to respectively receive and send messages, said host computer incorporating a database in which is stored adverse drug reaction data, patient data, and outgoing messages, said host computer further including a screen incoming message means connected to said input to screen incoming messages from a patient and search same for one or more keys which characterize said incoming messages, said host computer identifying said key(s) with one or more keywords stored in said drug reaction data to determine if there is a match therebetween, and said host computer including logic means connected with said database and an outgoing message generating means to determine in the event of a match whether an outgoing message should be sent, and if so sending same, said logic means also updating said patient data and/or drug reaction data with said matched keyword(s).

7. The system as claimed in claim 6 wherein said outgoing message generation means includes at least one interaction message which is intended to solicit a reply message from said patient, said reply message being screened by said screen incoming message means and any subsequent match being stored in said database.
